(19) United States
(12) Patent Application Publication
(10) Pub. No.: US 2019/0307057 A1
(43) Pub. Date: Oct. 10, 2019

(54) METHODS AND SYSTEMS FOR SEED VARIETY SELECTION

(71) Applicant: Precision Planting LLC, Tremont, IL (US)

(72) Inventors: Derek Sauder, Tremont, IL (US); Dale Koch, Tremont, IL (US); Doug Sauder, Washington, IL (US)

(21) Appl. No.: 16/449,630

(22) Filed: Jun. 24, 2019

Related U.S. Application Data
(63) Continuation of application No. 15/024,398, filed on Mar. 24, 2016.
(60) Provisional application No. 61/884,521, filed on Sep. 30, 2013.

(51) Int. Cl. A01C 7/04; A01C 7/08; A01C 7/12; A01C 21/00

(52) U.S. Cl. CPC A01C 7/046; A01C 21/005; A01C 7/128; A01C 7/081

(57) ABSTRACT

Described herein are methods and systems for planting seed. A system includes a row unit configured to open a planting trench. A first seed meter has a first coding scheme and receives a first seed type from a first hopper having the first coding scheme. A second meter has a second coding scheme and receives a second seed type from a second hopper having the second coding scheme.

### CROSS-REFERENCE TO RELATED APPLICATIONS

This application is a continuation of U.S. patent application Ser. No. 15/024,398, filed Mar. 24, 2016, as a national phase application under § 371(c) of International Patent Application PCT/US2014/058488, filed Sep. 30, 2014, which claims priority to U.S. Provisional Patent Application 61/884,521, filed Sep. 30, 2013, the disclosure of each of which is hereby incorporated herein in its entirety by this reference.

### FIELD

Embodiments of the present disclosure relate generally to systems and methods for planting seeds.

### BACKGROUND

Planters are used for planting seeds (e.g., corn, soybeans) in a field. On smaller planters, a farmer fills a seed hopper on every individual row unit of the planter. Multiple row units are mounted side-by-side along a single toolbar. At each row unit the seeds are fed from the hopper to a meter on the row unit, which meters seeds one by one into the trench opened by the row unit.

With larger planters (having, e.g., 48 row units) it has become common practice to have two side-by-side bulk hoppers. A blower blows seed from the bulk hoppers out to the individual row units through a plurality of lines. This cuts down the time per filling operation and the number of filling operations. Since the left hopper feeds one half of the row units and the right hopper feeds the other half, a farmer can fill one hopper with seed type A and the other hopper with seed type B and then see which seed type results in better performance and yield.

### BRIEF DESCRIPTION OF THE DRAWINGS

FIG. 1 illustrates a system (e.g., multi-hybrid planter system) with a coding scheme according to one embodiment;

FIG. 2 illustrates an embodiment in which the row unit 200 is a planter row unit with a coding scheme;

FIG. 3 illustrates a block diagram of a seed variety selection system with a coding scheme in accordance with one embodiment;

FIG. 4 illustrates a top view of a seed variety selection system having coded components for a coding scheme in accordance with one embodiment;

FIG. 5 illustrates a top view of an electrical system of a seed variety selection system having coded components for a coding scheme in accordance with one embodiment;

FIG. 6 illustrates an exemplary prescription map 600 in accordance with one embodiment;

FIG. 7 illustrates an exemplary coverage map 700 in accordance with one embodiment;

FIG. 8 illustrates a flow diagram of one embodiment for a method 800 of reducing a likelihood of operator error or preventing an operator error during the bulk hopper filling process; and

FIG. 9 shows an example of data processing system (e.g., device) in accordance with one embodiment.

### DETAILED DESCRIPTION

Described herein are methods and systems for improving seed variety selection. In one embodiment, a planting system includes a row unit configured to open a planting trench. A first seed meter has a first coding scheme and receives a first seed type from a first hopper having the first coding scheme. A second meter has a second coding scheme and receives a second seed type from a second hopper having the second coding scheme. Seed can be dispensed from the first seed meter or the second seed meter into the planting trench. The first and second coding schemes reduce or eliminate operator error during seed filling of bulk hoppers in the planting system.

The planting system can be a multi-hybrid planter that plants different hybrids throughout a field according to a prescription map that is based on soil characteristics in a field including soil type, etc. For example, a first hybrid may grow well in a first soil type while a second hybrids grows well in a second soil type. An operator (e.g., farmer) is not able to determine this effectively with conventional planters by filling the bulk hoppers with two different seed types because that method can only implement large side-by-side strips. In some embodiments, the multi-hybrid planter includes two meters on every row unit, e.g., as disclosed in Applicant's U.S. Provisional Patent Application No. 61/838,141, the entire disclosure of which is hereby incorporated by reference. In such embodiments, the operator fills one bulk hopper with seed type “A” and the other with seed type “B,” the “A” hopper sends seed to one meter on every row unit, and the “B” hopper sends seed to a second meter on every row unit. Using GPS, the planter decides where it is located on the prescription map and the “A”/“B” meters each switch on or off at the appropriate time so that the planter is planting the desired seed type at the desired location.

However, it may be easy for the operator to improperly plant different hybrids throughout a field according to a prescription map such that the wrong seed is planted in the wrong location in at least a portion of a region or field. Thus, the information learned in these situations may have no value in regards to hybrid performance because it is unknown which seed type was planted in which location. For example, the operator can fill the “A” hopper with the “B” seed type, mix two seed types in the bulk hopper, or some other variation. The operator may forget where in the field he filled which hopper with which seed type. The operator may connect the “A” seed distribution line to the “B” outlet, connect the “A” seed distribution line to the “B” meter, etc.

Embodiments of the present invention provide a coding scheme for certain components of the planting system in order to reduce or eliminate potential operator error while filling seed in the bulk hoppers or connecting the bulk hoppers to the appropriate seed lines and meters.

In the following description, numerous details are set forth. It should be appreciated, however, that the invention may be practiced without the specific details described herein and therefore should not be construed as limiting the scope of the invention. In some instances, well-known structures and devices are shown in block diagram form, rather than in detail, since those of skill in the art would readily understand these well-known structures and devices without further elaboration.

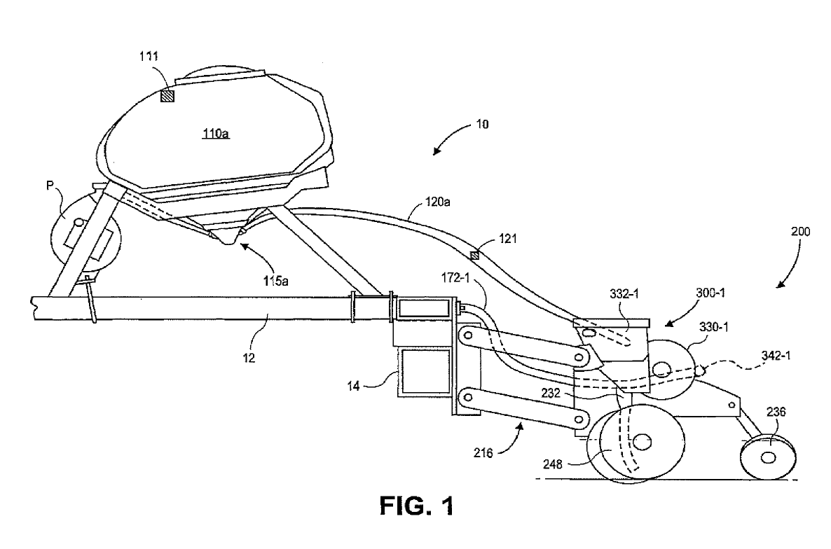

FIG. 1 illustrates a system (e.g., multi-hybrid planter system) with a coding scheme according to one embodiment. The system 10 includes a frame 12 having a transversely extending toolbar 14. A plurality of row units 200 are mounted to the toolbar 14 in transversely spaced relation. A plurality of bulk hoppers 110 are preferably supported by the frame 14 and in seed and pneumatic communication with the row units 200. Bulk hopper 110a includes a coded indicator 111 with a first coding scheme (e.g., color code, pattern code, numeric code, alphanumeric code, etc.). A second bulk hopper (not shown) may include a coded indicator with second coding scheme. A seed line 120a that is coupled to the bulk hopper 110a may also include a coded indicator 121 with the first coding scheme. A seed meter 300-1 may also include a coded indicator with the first coding scheme.

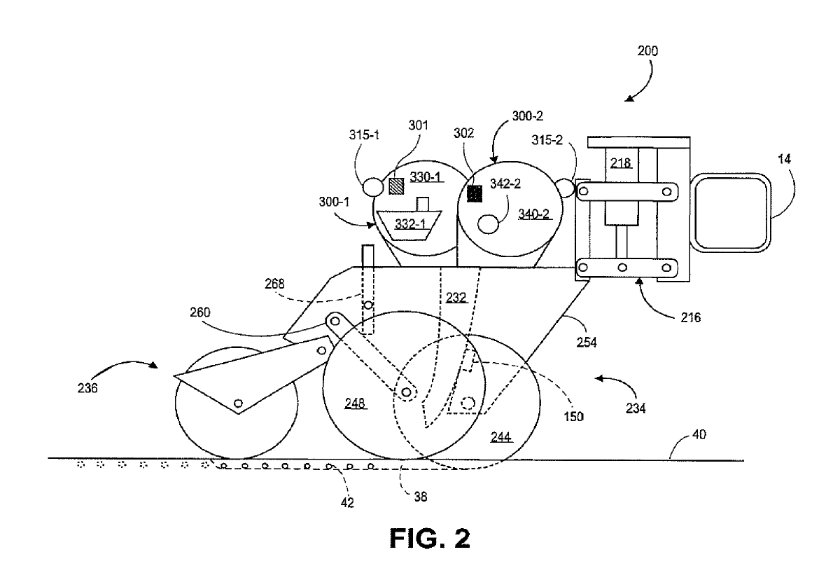

FIG. 2 illustrates an embodiment in which the row unit 200 is a planter row unit with a coding scheme. The row unit 200 is preferably pivotally connected to the toolbar 14 by a parallel linkage 216. An actuator 218 is preferably disposed to apply lift and/or down force on the row unit 200. An opening system 234 preferably includes two opening discs 244 rollingly mounted to a downwardly-extending shank 254 and disposed to open a v-shaped trench 38 in the soil 40. A pair of gauge wheels 248 is pivotally supported by a pair of corresponding gauge wheel arms 260; the height of the gauge wheels 248 relative to the opener discs 244 sets the depth of the trench 38. A depth adjustment rocker 268 limits the upward travel of the gauge wheel arms 260 and thus the upward travel of the gauge wheels 248. A down force sensor (not shown) is preferably configured to generate a signal related to the amount of force imposed by the gauge wheels 248 on the soil 40; in some embodiments the down force sensor comprises an instrumented pin about which the rocker 268 is pivotally coupled to the row unit 200.

Continuing to refer to FIG. 2, a first seed meter 300-1 is preferably mounted to the row unit 200 and disposed to deposit seeds 42 into the trench 38, e.g., through a seed tube 232 disposed to guide the seeds toward the trench. In other embodiments, the seed tube 232 is replaced with a seed conveyor such as one of the embodiments disclosed in Applicant's International Patent Application No. PCT/US2012/057327, the entire disclosure of which is hereby incorporated herein by reference, also published as U.S. Pat. No. 8,985,037, issued Mar. 24, 2015. A second seed meter 300-2 is preferably mounted to the row unit 200 and disposed to deposit seeds 42 into the same trench 38, e.g., through the same seed tube 232. Each of the seed meters 300-1, 300-2 preferably includes a seed side housing 330 having an auxiliary hopper 332 for storing seeds 42 to be deposited by the meter. Each of the seed meters 300-1, 300-2 preferably includes a vacuum side housing 340 (e.g., 340-2 is shown in FIG. 2) including a vacuum port 342 (e.g., 342-1 in FIG. 1, 342-2 in FIG. 2) for pulling a vacuum within the vacuum side housing. Each of the seed meters 300-1, 300-2 preferably includes a seed disc (not shown) that includes seed apertures (not shown). The seed disc preferably separates interior volumes of the vacuum side housing 340 and the seed side housing 330. In operation, seeds 42 communicated from the auxiliary hopper 332 into the seed side housing 330 are captured on the seed apertures due to the vacuum in the vacuum side housing and then released into the seed tube 232. Each of the meters is preferably powered by individual electric drives 315-1, 315-2 respectively. Each drive 315 is preferably configured to drive a seed disc within the associated seed meter 300. In other embodiments, the drive 315 may comprise a hydraulic drive or other motor configured to drive the seed disc.

A seed sensor 150 (e.g., an optical or electromagnetic seed sensor configured to generate a signal indicating passage of a seed) is preferably mounted to the seed tube 232 and disposed to send light or electromagnetic waves across the path of seeds 42. A closing system 236 including one or more closing wheels is pivotally coupled to the row unit 200 and configured to close the trench 38.

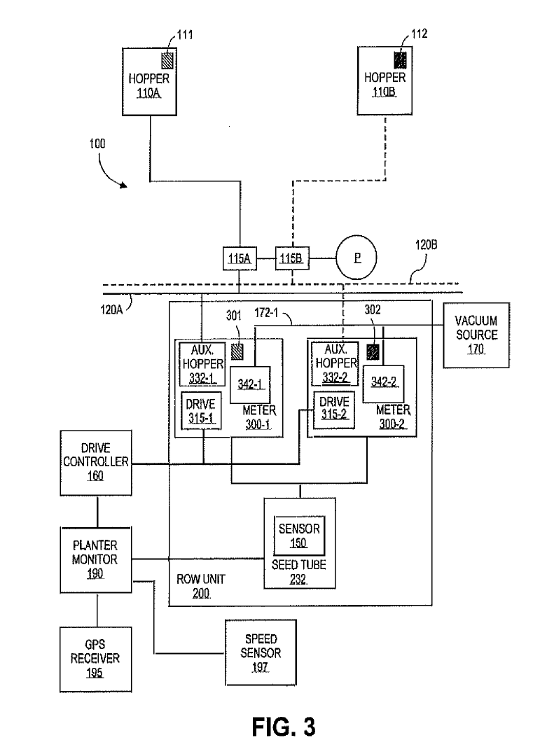

Certain components (e.g., seed meters 300-1, 300-2) of FIG. 2 include coded indicators with coding schemes (e.g., color code, pattern code, numeric code, alphanumeric code, etc.). For example, the seed meter 300-1 may include a first coded indicator 301 with a first coding scheme while the seed meter 300-2 may include a second coded indicator 302 with a second coding scheme. The coded indicators may be located anywhere on the seed meters or inlets that enter the seed meters or auxiliary hoppers. FIGS. 3-5 illustrate more examples of components with coded indicators and corresponding coding schemes in order to reduce or eliminate operator error while filling seed in a planter.

FIG. 3 illustrates a block diagram of a seed variety selection system with a coding scheme in accordance with one embodiment. The system 100 preferably includes a plurality of bulk hoppers 110 (e.g., two bulk hoppers 110a and 110b as illustrated). The first bulk hopper 110a preferably contains a first seed variety (e.g., a first corn seed variety or a first soybean variety); the second bulk hopper 110b preferably contains a second seed variety (e.g., a second corn seed variety or a second soybean variety). Bulk hopper 110a includes a coded indicator 111 with a first coding scheme (e.g., color code, pattern code, numeric code, alphanumeric code, etc.) while bulk hopper 110b includes a coded indicator 112 with a second coding scheme. Each bulk hopper is preferably in fluid communication with an individual seed entrainer 115. Each seed entrainer 115 is preferably mounted to a lower outlet of the associated bulk hopper 110. Each seed entrainer 115 is preferably in fluid communication with a pneumatic pressure source P and configured to convey air-entrained seeds through a plurality of seed lines 120 to the row units 200. Via a plurality of seed lines 120a, the bulk hopper 110a and the entrainer 115a are preferably in seed communication with a first seed meter 300-1 (e.g., with the auxiliary hopper 332-1) of each row unit 200 along the toolbar 14. In operation, the bulk hopper 110a supplies the first seed variety to the first meter 300-1 of each row unit 200. Via seed lines 120b, the bulk hopper 110b and the entrainer 115b are preferably in seed communication with the second seed meter 300-2 (e.g., with the auxiliary hopper 332-2) of each row unit 200 along the toolbar 14. In operation, the bulk hopper 110b supplies the second seed variety to the second meter 300-2 of each row unit 200. The seed meter 300-1 may include a first coded indicator 301 with a first coding scheme while the seed meter 300-2 may include a second coded indicator 302 with a second coding scheme. The coded indicators may be located anywhere on the seed meters or inlets that enter the seed meters or auxiliary hoppers.

Each drive 315-1, 315-2 is preferably in data communication with a drive controller 160. The drive controller is preferably configured to generate a drive command signal corresponding to a desired rate of seed disc rotation. The drive controller 160 is preferably in data communication with a planter monitor 190. The planter monitor 190 preferably includes a memory, a processor, and a user interface. The planter monitor is preferably configured to send drive command signals and/or desired rates of seed disc rotation to the drive controller 160. The planter monitor 190 is preferably in data communication with a GPS receiver 195 mounted to either the planter 10 or the tractor used to draw the planter. The planter monitor 190 is preferably in data communication with a speed sensor 197 (e.g., a radar speed sensor) mounted to either the planter 10 or the tractor. As used herein, “data communication” may refer to any of electrical communication, electronic communication, wireless (e.g., radio, microwave, infrared, sonic, near field, etc.) communication, or communication by any other medium configured to transmit analog signals or digital data.

Each vacuum port 342 (e.g., 342-1, 342-2) is preferably in fluid communication with a vacuum source 170 via a vacuum line 172 (e.g., 172-1). Both the first seed meter 300-1 and the second seed meter 300-2 of each row unit 200 are preferably in seed communication with (e.g., disposed to deposit seed into) a seed tube 232 associated with the row unit 200. The seed sensor 150 associated with the seed tube 232 of each row unit 200 is preferably in data communication with the planter monitor 190.

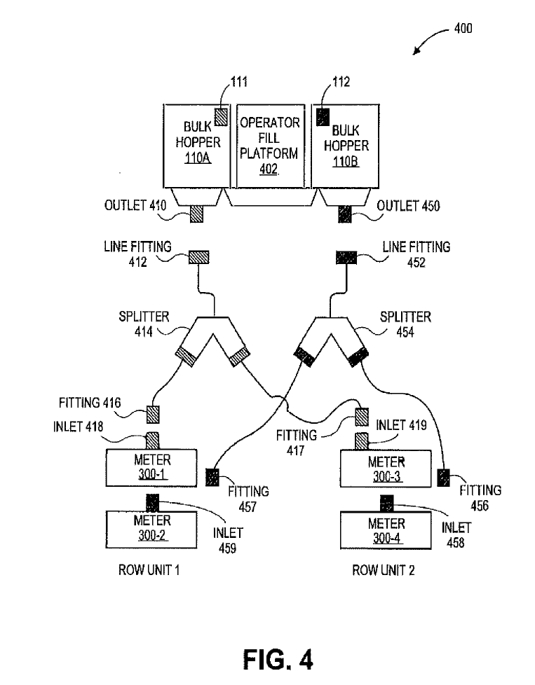

FIG. 4 illustrates a top view of a seed variety selection system having coded components of a coding scheme in accordance with one embodiment. The system 400 of FIG. 4 may include the same or similar components of FIG. 3, but fewer components have been illustrated in the system 400 in order to simplify the drawing and better illustrate the coding (e.g., color code, pattern code, numeric code, alphanumeric code, etc.) for preventing an operator error in operating the multi-hybrid systems of the disclosure. The system 400 includes an operator fill platform 402, bulk hopper 110a, and bulk hopper 110b. The operator can fill seed in these bulk hoppers. Bulk hopper 110 includes a coded indicator 111 with a first coding scheme. Bulk hopper 110a can be coupled to a first meter in any row unit such as meter 300-1 in row unit 1 or meter 300-3 in row unit 2. The outlet 410, fitting 412, splitter 414, fitting 416, and inlet 418 provide a pathway for seed communication from the bulk hopper 110a to the meter 300-1. The outlet 410, fitting 412, splitter 414, fitting 417, and inlet 419 provide a pathway for seed communication from the bulk hopper 110a to the meter 300-3. Each of these components may be coded (e.g., include coded indicators) to ensure that seed (e.g., seed type “A”) in hopper 110a is filled into meters 300-1 and 300-3. For example, these components including the bulk hopper 110a with the coded indicator 111 can be coded with a first color for seed type “A.” These components can include a coded indicator or at least a portion of one or more of these components includes a coding scheme.

Bulk hopper 110b includes a coded indicator 112 with a second coding scheme. Bulk hopper 110b can be coupled to a second meter in any row unit such as meter 300-2 in row unit 1 or meter 300-4 in row unit 2. The outlet 450, fitting 452, splitter 454, fitting 457, and inlet 459 provide seed communication from the bulk hopper 110a to the meter 300-2. The outlet 450, fitting 452, splitter 454, fitting 456, and inlet 458 provide seed communication from the bulk hopper 110b to the meter 300-4. Each of these components may be coded (e.g., include coded indicators) to ensure that seed (e.g., seed type “B”) in hopper 110b is filled into meters 300-2 and 300-4. For example, these components including the bulk hopper 110b with the coded indicator 112 can be coded with a second color for seed type “B.” These components can include a coded indicator or at least a portion of one or more of these components includes a coding scheme.

Each of the coded indicators described herein is preferably disposed to be viewed (preferably readily and easily) by the operator during operations in which the operator needs to identify which component corresponds to which component or seed type. For example, the coded indicators 111, 112 on the bulk hoppers 110a, 110b, respectively, are preferably located within the line of sight of an operator standing on the operator fill platform 402. Likewise, the coded indicator 301 is preferably disposed to be viewed (preferably readily and easily) by the operator when the operator is standing adjacent to the seed meter 300-1.

In some embodiments, all of the components providing seed communication from a bulk hopper to each seed meter receiving seed from the bulk hopper are coded in a corresponding (e.g., the same) fashion as the bulk hopper. For example, if the coded indicator 111 on the bulk hopper 110a is red, then the outlet 410, line fitting 412, splitter 414, fitting 416, inlet 418, fitting 417 and inlet 419 are preferably red, partly red, or include red coded indicators. In other embodiments, only a subset of the components is marked with a corresponding code as the bulk hopper. In other embodiments, the components are marked with a code corresponding to a different component--for example, line fitting 412, splitter 414, fitting 416, inlet 418, fitting 417 and inlet 419 can be coded in a corresponding (e.g., the same) fashion as the outlet 410 rather than the bulk hopper 110a.

In another embodiment, the coding is applied to the seed lines rather than at least some of the components discussed above. Alternatively, the coding is applied to the seed lines in addition to at least some of the components discussed above.

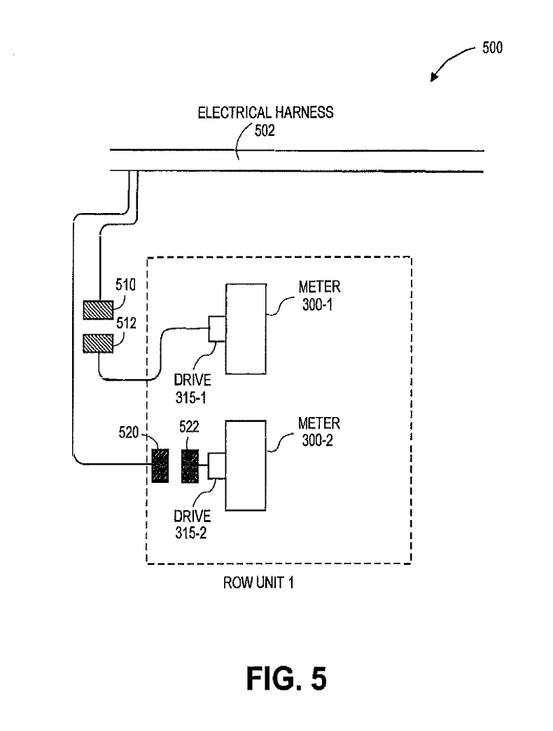

FIG. 5 illustrates a top view of an electrical system of a seed variety selection system having coded components in accordance with one embodiment. The electrical system 500 includes plugs 510, 512, 520, and 522 that have been coded (e.g., color code, pattern code, numeric code, alphanumeric code, etc.) to prevent or reduce a likelihood of an operator error while operating a multi-hybrid planter. The electrical system 500 includes an electrical harness 502 (e.g., bus) that provides power to the drive 315-1 of meter 300-1 if the plugs 510 and 512 are connected. The electrical harness 502 also provides power to the drive 315-2 of meter 300-2 if the plugs 520 and 522 are connected. Each pair of plugs (e.g., 510 and 512, 520 and 522) may be coded to ensure that seed (e.g., seed type “A”) in hopper 110a is filled into an appropriate meter such as meter 300-1 and seed (e.g., seed type “B”) in hopper 110b is filled into an appropriate meter such as meter 300-2. For example, the plugs 510 and 512 can be coded with a first color for seed type “A” and the plugs 520 and 522 can be coded with a second color for seed type “B.”

In some embodiments, the electrical system uses a corresponding (e.g., the same) coding scheme as the system 400 of FIG. 4. For example, if the coded indicator 111 on the bulk hopper 110a is red, then the plug 510 and the plug 512 are preferably coded with the color red.

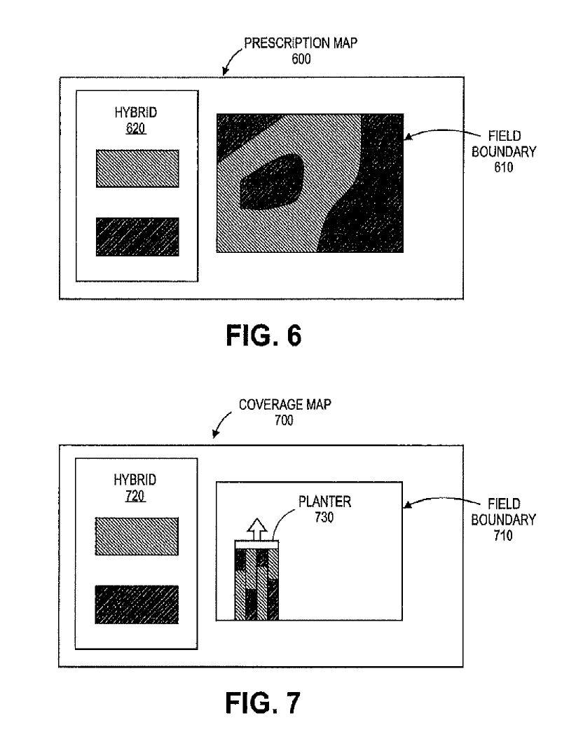

FIG. 6 illustrates an exemplary prescription map 600 in accordance with one embodiment. The prescription map 600 is displayed on a monitor (e.g., planter monitor 190) in a tractor cab and used by the monitor (or the operator) to control the planter and plant the appropriate seed in the appropriate region of the field based on soil type or some other characteristic that affects seed growth and performance. A GPS (e.g., GPS receiver 195) can provide data to the monitor for generating the prescription map. The prescription map 600 can be coded in the same or similar manner as the components are coded in the embodiments discussed herein. For example, the hybrid key 620 can include a first color to indicate a first region for planting seed type “A” and a second color to indicate a second region for planting seed type “B.” The first and second colors are used inside the field boundary 610 on the map 600. The first region on the prescription map may have a first soil type or characteristic while the second region may have a second soil type or characteristic.

FIG. 7 illustrates an exemplary seed coverage map 700 in accordance with one embodiment. The seed coverage map 700 is displayed on a monitor (e.g., planter monitor 190) in a tractor cab in order for the operator to see which type of seed variety has been planted in a particular region of the field. The seed coverage map 700 can be coded in the same or similar manner as the components are coded in the embodiments discussed herein. For example, the hybrid key 720 can include a first color to indicate a first region that has been planted with seed type “A” and a second color to indicate a second region that has been planted with seed type “B.” The first and second colors are used inside the field boundary 710 on the map 700 and show the “as-planted” seed type in relation to a planter 730. The first color may indicate a first seed type while the second color indicates a second seed type. In one embodiment, the seed coverage map is updated dynamically in real-time as the planter moves through the field.

In one embodiment, the hybrid key 620 and the hybrid key 720 are consistent with the coding used in the system 400 of FIG. 4 so that the monitor provides a visual association between the coded components (e.g., the bulk hoppers 110) and the seed types being planted in the field. For example, if the bulk hopper 110a is coded with the color red, then the color red is used in the hybrid keys 620 and 720 to identify areas planted (or to be planted) with the seed type contained in bulk hopper 110a. In one such embodiment, when the process 800 described below is carried out, the processing logic (e.g., of a smart phone) used to carry out the process communicates (e.g., via a network interface) the seed type associated with (e.g., used to fill) a bulk hopper to the monitor 190 and the monitor 190 identifies the seed type adjacent to the corresponding color in the hybrid key 720.

In another embodiment, the seed coverage map is modified by optionally showing a secondary characteristic (e.g., seed population, depth, etc.). For example, the seed population may indicate a number of seeds planted per acre. The secondary characteristic may be mapped and displayed as a different color shade or pattern of the respective first or second color. For example, if a first color is red, then a red region planted at a higher population can be displayed as a dark red color. A red region planted at a lower population can be displayed as a light red color.

The different coding schemes disclosed herein such as a color scheme work with different patterns rather than colors. Additionally, each of the color-coded connectors could alternatively or additionally be designed so that a “first color” component or connector will not fit with a “second color” component or connector, etc. For example, a red seed type “A” fitting may include a pin sized to slidingly engage a slot in a corresponding red seed type “A” inlet (thus coupling the fitting to the inlet), but the red fitting pin is preferably too large to engage a slot in a non-corresponding inlet (e.g., a blue seed type “B” inlet) such that the red fitting will not connect with the non-corresponding inlet, preventing an operator error. Similar design may be used to prevent a red seed type “A” plug from operably engaging a blue seed type “B” plug.

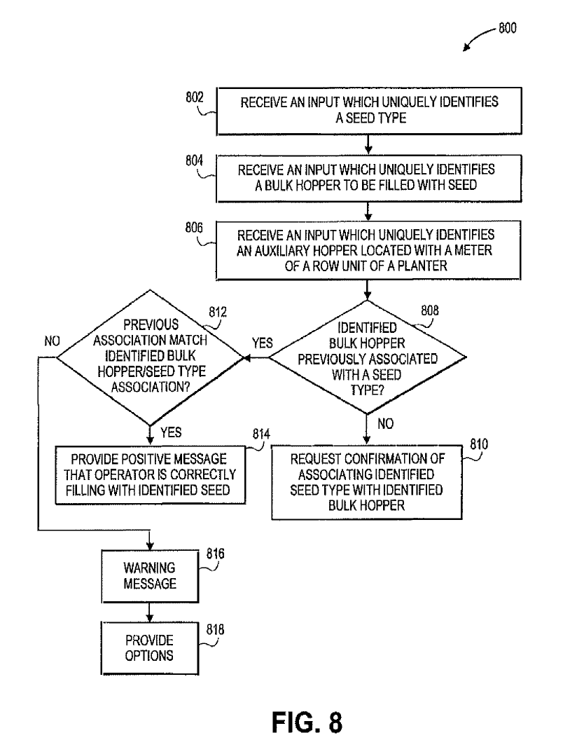

FIG. 8 illustrates a flow diagram of one embodiment for a method 800 of “fool-proofing” or preventing an operator error during the bulk hopper filling process. The method 800 is performed by processing logic that may comprise hardware (circuitry, dedicated logic, etc.), software (such as is run on a general purpose computer system or a dedicated machine or a device), or a combination of both. In one embodiment, the method 800 is performed by processing logic of a smart cellular phone, mobile device, tablet device, or other electronic device that executes instructions of a software application with processing logic. The software application can be initiated by an operator and the following operations of method 800 may be performed.

At block 802, the processing logic receives an input (e.g., operator input, barcode) which uniquely identifies a hybrid seed type. The operator may use an electronic device having the software application to scan a barcode on a seed bag or on a large seed box used with mechanical seed tenders. The barcode uniquely identifies the seed type (i.e., seed variety). Alternatively, the operator can select the hybrid seed type using a user interface provided by the processing logic and the software application. For example, the operator can select the hybrid from a drop-down list provided by the software application of the electronic device.

At block 804, the processing logic receives an input (e.g., operator input, barcode) which uniquely identifies a bulk hopper of a planter that is being filled with seed. The operator may use the device to scan a barcode on a bulk hopper. The barcode uniquely identifies the bulk hopper (e.g., bulk hopper A, bulk hopper B, etc.). The barcode can be in a similar location as the coding (e.g., color marking) that is illustrated on the bulk hoppers in FIG. 4. Alternatively, the barcode can be located in a different location. In an embodiment, the barcode is replaced with a color marking. Alternatively, the operator can indicate which hopper is being filled using a user interface provided by the processing logic and the software application. In another embodiment, the operator scans the barcode on the bulk hopper or selects the bulk hopper and then selects the hybrid from a drop-down list. At optional block 806, the processing logic receives an input (e.g., operator input, barcode) which uniquely identifies an auxiliary hopper located with a meter of a row unit of the planter. The auxiliary hopper holds a small amount of seed at the meter. The operator may use the device to scan a barcode on the auxiliary hopper. The barcode uniquely identifies the auxiliary hopper (i.e., auxiliary hopper A, auxiliary hopper B, etc.) in order to determine the type of seed that is left in a meter when planting operations are completed.

At block 808, the processing logic determines whether the identified bulk hopper that is being filled by the operator has been previously associated with a seed type. If there is no previous association between the identified bulk hopper and a seed type in memory, then the processing logic generates a user interface that requests confirmation of associating the identified seed type with the identified bulk hopper at block 810.

If a previous association exists, then processing logic determines if the previous association matches the association between the identified hopper and the identified (scanned or selected) seed type at block 812. The processing logic at block 814 provides a user interface with a visual confirmation message that the operator is filling the right bulk hopper if a match occurs at block 812. Optionally, the processing logic may also generate an audio confirmation message.

If no match occurs at block 812, then the processing logic at block 816 provides a user interface with a visual warning message that the identified bulk hopper is associated with a different seed than the seed type that is being filled by the operator into the bulk hopper. Optionally, the processing logic may also generate an audio warning message. At block 818, the processing logic provides a user interface with multiple options. A first option is removing the previous association between seed type and identified hopper and then associate the identified hopper with a new seed type. A second option allows the operator to correct his error by scanning a code corresponding to the previously associated seed type. After completion of operations 810, 814, or 818, the processing logic may determine based on input received from the operator whether additional bulk hoppers and future filling operations need to be performed. If so, the operations of method 800 can be repeated. If no additional fill operations are needed and no seed is left in the bulk hopper or the meters, then processing logic may receive input from the operator that instigates a “flush” of all seed/hopper associations in order to avoid future warnings.

In some embodiments, the operations of the methods disclosed herein can be altered, modified, combined, or deleted. For example, the operation of block 804 can occur prior to the operation of block 802 of FIG. 8. The operation of block 806 may be removed. The methods in embodiments of the present invention may be performed with a device, an apparatus, or data processing system as described herein. The device, apparatus, or data processing system may be a conventional, general-purpose computer system or special purpose computers, which are designed or programmed to perform only one function, may also be used.

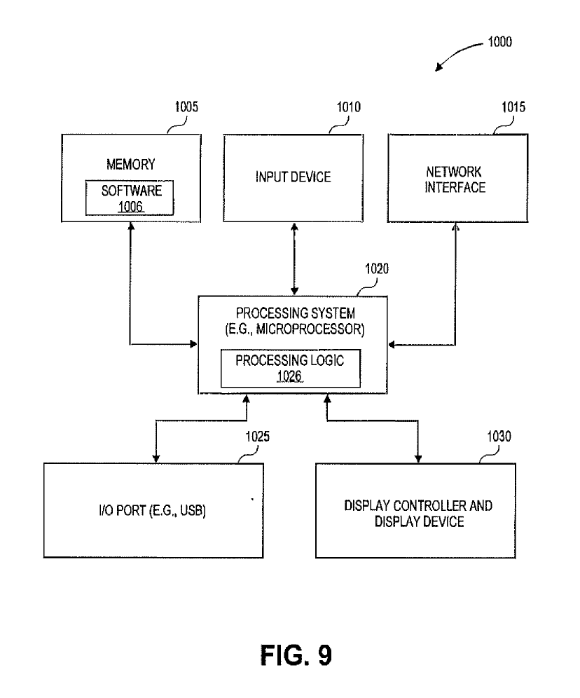

FIG. 9 shows an example of data processing system (e.g., device) in accordance with one embodiment. For example and in one embodiment, the system may be implemented as a data processing device such a desktop computer, server, laptop, tablet, computer terminal, a handheld computer, a personal digital assistant, a cellular telephone, a camera, a smart phone, mobile phone, an email device, or a combination of any of these or other data processing devices.

In other embodiments, the data processing system may be a network computer or an embedded processing device within another device, or other types of data processing system having fewer components or perhaps more components than that shown in FIG. 9.

The data processing system 1000 shown in FIG. 9 includes a processing system 1020, which may be one or more microprocessors or which may be a system on a chip (integrated circuit) and the system also includes memory 1005 for storing data and programs for execution (software 1006) by the processing system. The memory 1005 can store, for example, the software components described above such as the software application for executing the operations of method 800 and memory 1005 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

A display controller and display device 1030 can provide a visual user interface for a user or operator. The system also can include a network interface 1015 to communicate with another data processing system. The network interface can be a WLAN transceiver (e.g., WiFi), an infrared transceiver, a Bluetooth transceiver, a wireless cellular telephony transceiver, Ethernet or other. It will be appreciated that additional components, not shown, may also be part of the system in certain embodiments, and in certain embodiments fewer components than shown in FIG. 9 may also be used in a data processing system. The system further can include one or more input/output (I/O) ports 1025 to enable communication with another data processing system or device. The I/O port may connect the data processing system to a USB port, Bluetooth interface, card reader, document scanner, printer etc.

The data processing system also can include one or more input devices 1010 which are provided to allow a user to provide input to the system. These input devices may be a keypad or a keyboard or a touch screen overlaid and integrated with a display device such as display device 1030. The input device may be used with an integrated image capture device to scan one or more barcodes from seed bags and components of a planting system as discussed herein. It will be appreciated that one or more buses, not shown, may be used to interconnect the various components as is well known in the art.

An article of manufacture may be used to store program code providing at least some of the functionality of the embodiments described above. An article of manufacture that stores program code may be embodied as, but is not limited to, one or more memories (e.g., one or more flash memories, random access memories--static, dynamic, or other), optical disks, CD-ROMs, DVD-ROMs, EPROMs, EEPROMs, magnetic or optical cards or other type of machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention. The specification and drawings are, accordingly, to be regarded in an illustrative sense rather than a restrictive sense.

The memory 1005 may be a machine-accessible non-transitory medium on which is stored one or more sets of instructions (e.g., software 1006) embodying any one or more of the methodologies or functions described herein. The software 1006 may also reside, completely or at least partially, within the memory 1005 and/or within the processing system 1020 during execution thereof by the system 1000, the memory and the processing system also constituting machine-accessible storage media. The software 1006 may further be transmitted or received over a network via the network interface device 1015.

In one embodiment, a machine-accessible non-transitory medium (e.g., memory 1005) contains executable computer program instructions which when executed by a data processing system cause the system to perform a method (e.g., method 800). The operations of the method include receiving an input (e.g., operator input, barcode) which uniquely identifies a hybrid seed type. The operator may use a device (e.g., system 1000) to scan a barcode on a seed bag or on a large seed box used with mechanical seed tenders. The barcode uniquely identifies the seed type (i.e., seed variety). Alternatively, the operator can select the hybrid seed type using a user interface generated by the processing logic and software 1006. The method includes receiving an input (e.g., operator input, barcode) which uniquely identifies a bulk hopper that is being filled with seed. The operator may use the device to scan a barcode on a bulk hopper. The barcode uniquely identifies the bulk hopper (i.e., bulk hopper A, bulk hopper B, etc.). In an embodiment, the barcode is replaced with a color marking. Alternatively, the operator can indicate which hopper is being filled using the software application (e.g., software 1006) in the form of computer executable instructions. In another embodiment, the operator scans the barcode on the bulk hopper or selects the bulk hopper and then selects the hybrid from a drop-down list. The method optionally includes receiving an input (e.g., operator input, barcode) which uniquely identifies an auxiliary hopper located with a meter of a row unit of a planter. The operator may use the device to scan a barcode on the auxiliary hopper. The barcode uniquely identifies the auxiliary hopper (i.e., auxiliary hopper A, auxiliary hopper B, etc.) in order to determine the type of seed that is left in a meter when planting operations are completed.

The method includes determining whether the identified bulk hopper that is being filled by the operator has been previously associated with a seed type. If there is no previous association between the identified bulk hopper and a seed type in memory of the device (e.g., memory 1005), then the processing logic generates a user interface that requests confirmation of associating the identified seed type with the identified bulk hopper.

The method further includes determining if there is a previous association between the identified bulk hopper and a seed type in memory. If the previous association matches the identified (scanned or selected) seed type, then the method provides a user interface with a visual confirmation message that the operator is filling the right bulk hopper. Optionally, the method may also generate an audio confirmation message.

If the previous association does not match the scanned or selected seed type, then the method provides a user interface with a visual warning message that the identified bulk hopper is associated with a different seed than the seed type that is being filled by the operator into the bulk hopper. Optionally, the method may also generate an audio warning message. The method provides a user interface with multiple options. A first option is removing the previous association between seed type and identified hopper and then associate the identified hopper with a new seed type. A second option allows the operator to correct his error by scanning a code corresponding to the previously associated seed type.

While the machine-accessible non-transitory medium (e.g., memory 1005) is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present invention. The term “machine-accessible non-transitory medium” shall accordingly be taken to include, but not be limited to, solid-state memories, optical and magnetic media, and carrier wave signals.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A planter for planting seed of multiple seed types in a single planting pass during row-crop planting of an agricultural field and controlling seed delivery speed, the planter comprising:
a frame supporting multiple row units;
a seed storage system for separately storing seeds of multiple seed types on the planter;
a seed-metering system at each of the multiple row units selectively receiving the seeds of the multiple seed types from the seed storage system; and
a seed delivery speed control system receiving the seeds from the seed-metering system and releasing the seeds for planting of an agricultural field, wherein the seed delivery speed control system adjusts a delivery speed of the seeds based on at least one of a travel speed of the planter and a target spacing distance corresponding to the one of the multiple seed types delivered from the seed-metering system to the seed delivery speed control system.

2. The planter of claim 1, wherein the seed delivery speed control system includes a seed delivery speed control device extending away from an outlet of the seed meter to direct the seeds toward a seed trench in the agricultural field.

3. The planter of claim 2, wherein the seed delivery speed control device comprises a speed tube with an upper end receiving the seeds from the seed meter and a lower end extending away from an outlet of the seed meter to direct the seeds toward a seed trench in the agricultural field.

4. The planter of claim 3, wherein the speed tube includes a belt configured to rotate at a variable speed for adjusting delivery speed of the seeds released from the speed tube.

5. The planter of claim 1, wherein the seed delivery speed control system is configured to adjust the delivery speed of the seeds to approximate a detected travel speed of the planter with the seeds delivered in a delivery direction that is opposite a travel direction of the planter to provide a seed drop path that is substantially vertical-only with respect to a seed trench of the agricultural field.

6. The planter of claim 1, wherein the seed delivery speed control system is configured to adjust the delivery speed of the seeds to approximate a target spacing between adjacent seeds in a common seed trench based on a predetermined target seed population for a corresponding one of the multiple seed types of seeds being released when the adjustment is made.

7. The planter of claim 1, wherein the seed delivery speed control system includes at least one sensor arranged for detecting delivery speed of the seeds.

8. The planter of claim 7, wherein the seed delivery speed control system includes a pair of spaced apart sensors arranged for detecting movement of a heed past each of the sensors for determining detecting speed of the seeds delivered from the seed delivery speed control system.

9. The planter of claim 8, wherein the pair of spaced apart sensors is arranged relative to a discharge tube of the seed delivery speed control system for detecting movement of each seed through the discharge tube.

10. The planter of claim 1, further comprising a charging system configured to selectively deliver seeds of the multiple seed types to the seed meter, wherein the charging system is arranged upstream of the seed meter and the seed delivery speed control system is arranged downstream of the seed meter.

11. The planter of claim 10, wherein the seed storage system includes a bulk storage system for separately storing seeds of multiple types on the planter.

12. The planter of claim 11, wherein the bulk storage system is configured for separately storing seeds of at least some of the multiple seed types on the planter at a remote location relative to the multiple row units.

13. The planter of claim 11, wherein the seed storage system includes an on-row storage system separately storing the seeds of the multiple seed types at the row units and wherein the charging system selectively transfers seeds of the multiple seed types from the bulk storage system to the on-row storage system.

14. The planter of claim 11, further comprising a diverter system arranged between the bulk storage system and the on-row storage system for selectively defining passages between the bulk storage system and the on-row storage system to direct seeds of the multiple seed types into corresponding ones of multiple compartments of the on-row storage system.

15. The planter of claim 14, wherein the diverter system includes a gate system with gates configured to actuate for defining the passages between the bulk storage system and the on- row storage system to direct seeds of the multiple seed types into corresponding ones of multiple compartments of the on-row storage system.

16. A planter for planting seed of multiple seed types in a single planting pass during row-crop planting of an agricultural field and controlling seed delivery speed, the planter comprising:
a frame supporting multiple row units;
a seed storage system for separately storing seeds of multiple seed types on the planter;
a seed-metering system at each of the multiple row units selectively receiving the seeds of the multiple seed types from the seed storage system; and
a speed tube receiving the seeds from the seed-metering system and releasing the seeds for planting of an agricultural field, the speed tube having a conveyance mechanism configured to move at an adjustable speed to vary the delivery speed of the seeds.

17. The planter of claim 16, wherein the conveyance mechanism is a belt rotated by a belt drive at a variable speed to adjust the delivery speed of the seeds based on at least one of a travel speed of the planter and a target spacing distance corresponding to the one of the multiple seed types delivered from the seed-metering system to the seed delivery speed control system.

18. The planter of claim 17, wherein the seed storage system includes a bulk storage system for separately storing seeds of multiple types on the planter and an on-row storage system separately storing the seeds of the multiple seed at the row units for selective delivery to the seed-metering system and a charging system selectively transfers seeds of the multiple seed types from the bulk storage system to the on-row storage system.

19. A method of planting seed of multiple seed types in a single planting pass during row-crop planting of an agricultural field and controlling seed delivery speed, the method comprising:
separately storing seeds of multiple seed types on a planter having multiple row units;
selectively delivering seeds of the multiple seed types to a seed-metering system at each of the multiple row units;
singulating the seeds in the seed-metering system;
delivering the singulated seeds from the seed-metering system to a seed delivery speed control system releasing the singulated seeds to a seed trench of the agricultural field; and
adjusting a delivery speed of the seeds released from the seed delivery speed control system based on at least one of a travel speed of the planter and a target spacing distance corresponding to the one of the multiple seed types being released from the seed delivery speed control system.
